(19) United States
(12) Patent Application Publication
(10) Pub. No.: US 2021/0244065 A1
(43) Pub. Date: Aug. 12, 2021

(54) METHOD AND APPARATUS FOR PROCESSING STONE FRUIT

(71) Applicant: CFT S.P.A., 43122 PARMA (IT)

(72) Inventors: ROBERTO CATELLI, PARMA (IT); ROBERTO MONTANI, CORTEMAGGIORE (IT)

(21) Appl. No.: 17/053,769

(22) PCT Filed: May 13, 2019
(86) PCT No.: PCT/IB2019/053925

§ 371 Date: Nov. 7, 2020

(30) Foreign Application Priority Data
May 15, 2018 (IT) 102018000005396

(51) Int. Cl. A23N 4/04; A23N 1/02; A23L 19/00

(52) U.S. Cl. CPC A23N 4/04; A23V 2002/00; A23L 19/09; A23N 1/02

(57) ABSTRACT

A method for processing fruit (10) that has a central stone (11) and flesh (12) surrounding the stone, said method comprising the steps of:—positioning the fruit (10) inside a casing (2) in which a rotating element (3) rotates, said casing (2) comprising at least one outlet hole (21);—removing from the stone (11) at least a part of the flesh (12) attached to the stone (11); The step of removing from the stone (11) at least a part of the flesh (12) attached to the stone (11) comprises the step of pushing the fruit (10) by centrifugal force against the casing (2) and bringing said rotating element (3) into contact with the flesh (12) until the stone (11) manages to pass through said at least one outlet hole (21). The method further comprises the steps of:—obtaining a semi-processed product downstream of the casing (2) formed by the stone (11) and the flesh (12) that was separated from the stone (11);—making said semi-processed product pass through a sieve (4) that retains the stone (11) allowing the passage of the flesh (12).

### TECHNICAL FIELD

The object of the present invention is a method and apparatus for processing stone fruit.

It is used in particular for producing fruit purée.

### PRIOR ART

An apparatus is known that envisages the use of two machines placed in series: a stone remover and a stone cleaner positioned downstream.

The stone remover comprises two counter-rotating rollers. A presser presses the fruit against the two rollers. One of the two rollers is made of rubber. The other is made of metal material and is serrated. During rotation, the serrated roller removes the flesh from the fruit until the volume of flesh around the stone is sufficiently reduced to allow the latter to be swallowed up within the rubber roller. Immediately downstream, there is a cusp-shaped deflector that identifies two slides, one that directs the flesh and one for the evacuation of the stone.

The stone with which a part of the flesh is still associated is then introduced into the aforementioned stone cleaning device. Such device comprises a centrifugal machine with blades that pushes the stones against a sieve for recovering a further part of the flesh. The purée obtained from the flesh closest to the stone is more fibrous and has a slightly different colour. It is of poorer quality and is usually mixed in reduced percentages with the purée obtained directly from the stone remover.

A drawback of such constructive solution is connected with the fact that during use the rubber roller gets worn, releasing microscopic fragments of rubber that due to the minuscule dimensions are not withheld by any filters positioned downstream. This compromises the product quality.

Furthermore, the production takes place cold and therefore the product is very sensitive to the production time (including stop time in storage tanks); the longer the time, the higher the oxidation (with negative consequences on the quality).

### Aim of the Invention

The object of the present invention is to propose a method and apparatus for processing fruit that allows the drawbacks illustrated above to be overcome.

In particular, an aim of the present invention is to provide a method and an apparatus that allow the product quality to be optimised.

The stated technical task and specified objects are substantially achieved by an apparatus and a method comprising the technical features disclosed in one or more of the appended claims.

### BRIEF DESCRIPTION OF THE DRAWINGS

Further characteristics and advantages of the present invention will become more apparent from the following indicative and therefore non-limiting description of a method and apparatus as illustrated in the appended drawings, in which:

FIG. 1 shows a lateral view of an apparatus according to the present invention;

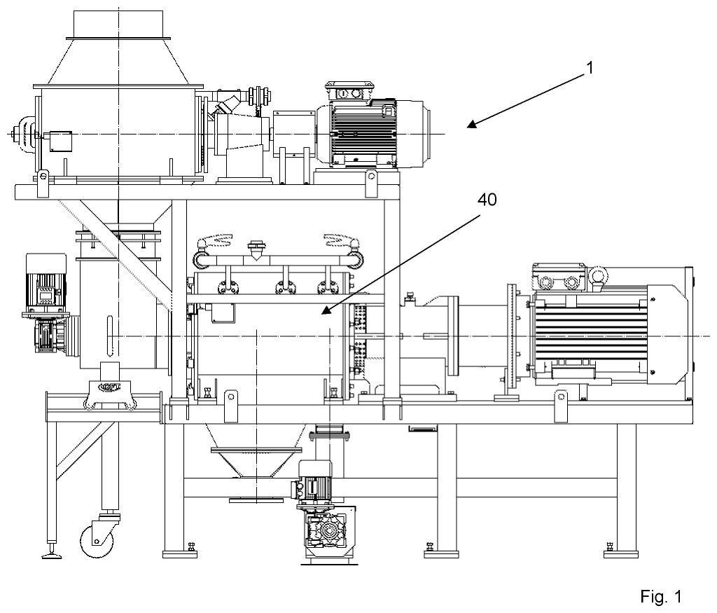

FIG. 2 shows a sectional view of FIG. 1;

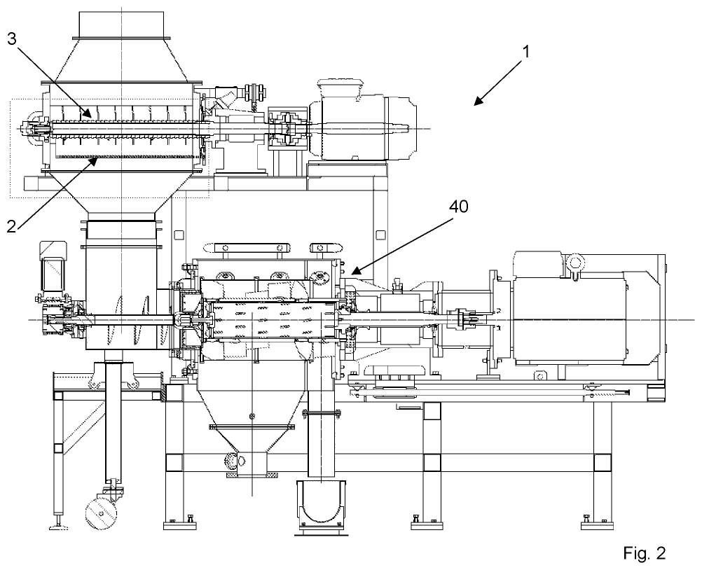

FIGS. 3 and 4 show enlarged details of FIG. 2;

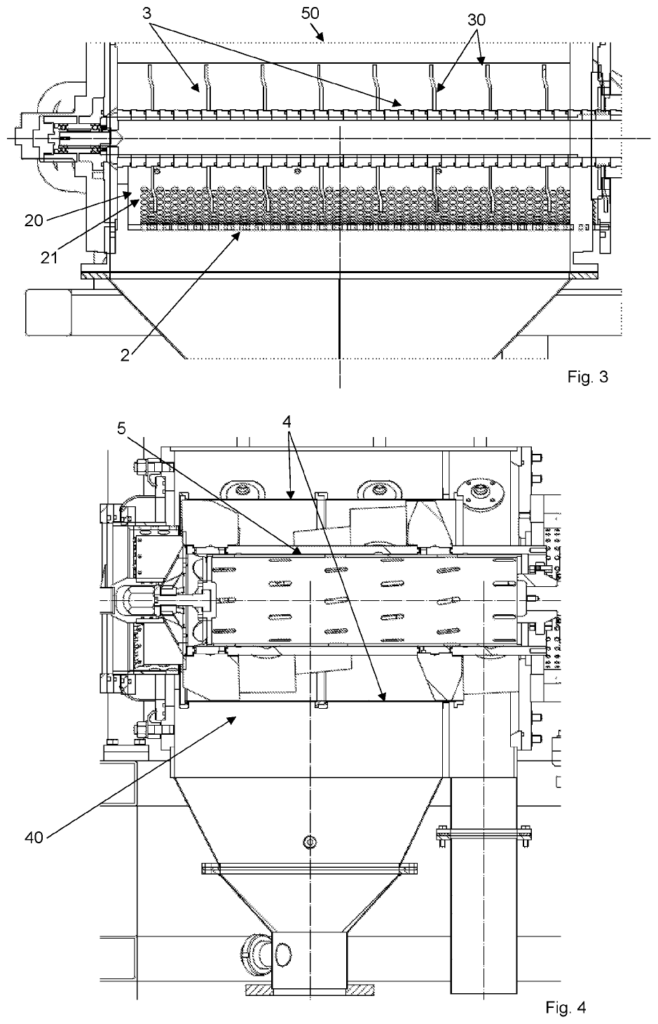

FIG. 5 highlights a step of the method according to the present invention.

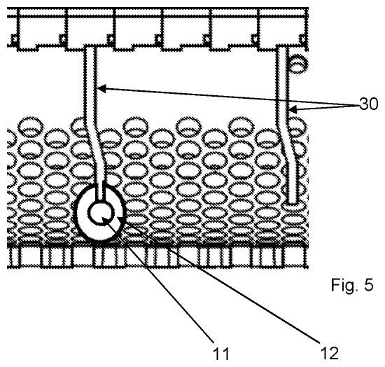

### DETAILED DESCRIPTION OF PREFERRED EMBODIMENTS OF THE INVENTION

In the appended figures the reference number 1 indicates a processing apparatus for fruit with a central stone and flesh surrounding the stone.

For example, such fruit could be peach, apricot or mango.

The apparatus 1 comprises a rotating element 3 and a casing 2 inside which said rotating element 3 rotates (together they define the stone remover that allows the flesh to be separated from the stone). Preferably the rotating element 3 is coaxial with the casing 2. The casing 2 is static.

The casing 2 comprises at least one outlet hole 21 for letting out the stone and the flesh detached from the stone. The stone 21 is advantageously placed on a lower portion of the casing 2 in order to facilitate the outlet by gravity. Advantageously there are various holes 21, preferably alongside each other. The following description with reference to said at least one hole 21 can be advantageously repeated for one or more of the remaining holes 21.

At the top the casing 2 has an opening 50 for the inlet of the fruit. Advantageously, upstream of the casing 2 there may be a rotary star valve; it allows the introduction of the fruit, at the same time limiting the inlet of air.

The rotating element 3 is suitable to remove the flesh attached to the stone and to draw in rotation the fruit placed inside the casing 2 pushing it by centrifugal force against the casing 2. The rotating element 3 comprises one or more blade elements 30.

The blade element 30 rotates inside the casing 2 maintaining a radial distance from said casing 2 such as to allow the stone 11 to remain near the casing 2 without coming into contact with the blade element 30. Typically, the blade element 30 has a radial distance from the casing 2 that is variable according to the geometry of the element to be treated. By way of non-limiting example, such radial distance could be comprised between 3 and 4 centimetres. In a particular constructive solution the rotary element 3 and the casing 2 could not be coaxial. The blade element 30 is advantageously serrated (preferably on the outer edge). In an exemplified but non-limiting solution, the blade element 30 extends radially along a length comprised between 50% and 80% of the radial distance between the casing 2 and a base of the blade element 30.

The apparatus 1 further comprises a means 40 for separating the stone from the flesh already detached from the stone. Such separation means 40 is placed downstream of the casing 2. Appropriately the separation means 40 comprises a first refining device comprising an impeller 5 that rotates in a sieve 4 and pushes the flesh through the sieve 4. The stones are instead retained by the sieve 4. The sieve 4 can comprise holes having a diameter comprised between 5 and 10 millimetres (or however having a passage section comprised between 19.5 mm² and 78.5 mm²).

The separation means 40 also contributes to separating from the stone at least a part of the flesh attached to the stone. On this point, the propeller 5 is bladed and draws in rotation the stone 11 pushing it (due to the effect of the radial thrust imposed by the blade and by centrifugal effect) against the sieve 4 to determine a further detachment of flesh still attached to the stone 11.

The object of the present invention is also a method for processing fruit 10 with a central stone 11 and flesh 12 surrounding the stone (as indicated previously for example the fruit could be peach, apricot, mango). Appropriately the method can be implemented by a fruit processing apparatus 1 having one or more of the characteristics described hereinabove.

The method comprises the step of positioning the fruit 10 inside a casing 2 in which a rotating element 3 rotates. Appropriately, the rotating element 3 comprises one or more blade elements 30 (in the preferred solution they are arranged radially starting from a central rotor). In an exemplified solution the rotating element 3 rotates at a speed comprised between 600 and 800 revolutions per minute, preferably at 700 rpm. The casing 2 comprises an outlet hole 21.

Appropriately, the method comprises the step of removing (detaching) from the stone 11 at least a part of the flesh 12 attached to the stone 11. This comprises the step of pushing by centrifugal force the fruit 10 against the casing 2 and bringing said rotating element 3 (in particular the blade element 30) into contact with the flesh 12 until the stone can pass through said at least one outlet hole 21. The rotating element 3 coming into contact with the flesh 12 of the fruit nibbles (cuts or however minces) the fruit so that each individual fruit reduces its volume. When the dimension is sufficiently reduced the fruit can be evacuated from the casing 2 through said at least one outlet hole 21. Typically this happens by gravity. When the stone is evacuated from the casing 2 it may still be attached to some flesh. This can also be removed through subsequent processing (which will be explained below).

The step of removing the flesh 12 from the stone 11 comprises the step of positioning by centrifugal effect the stone 11 between the casing 2 and an imaginary circumference travelled by the outer diameter of the blade element 30. The blade element 30 removes at least a part of the flesh attached to the stone 11 without coming into contact with the stone 11.

The blade element 30 rotates inside the casing 2 maintaining a radial distance from said casing 2 such as to allow the stone 11 to remain near the casing 2 without coming into contact with the blade element 30. Typically, the blade element 30 has a radial distance from the casing 2 that is variable according to the geometry of the element to be treated. The blade element 30 is advantageously serrated (preferably on the outer edge). The description with reference to one blade element 30 may also be repeated for the other blade elements 30. Appropriately the casing 2 and said one or more blade elements 30 are removably connected. This allows them to be replaced as a function of the type of product whose stone is to be removed. In fact, the radial distance of the blade element 3 from the casing, like the geometry of said at least one outlet hole 21, must be carefully selected.

In fact, it is important to find the right geometric balance of the rotating element 3 and the casing 2. In fact, if the blade element 30 ground part of the stone, the purée obtained would be compromised by the bitter taste of the stone. Vice versa, if an excessive quality of flesh were left on the stone, there would be excessive waste (or slower processing because of the need to recover large volumes of flesh later, with the risk that it has oxidised more in the meantime).

Said at least one outlet hole comprises a slit that allows the passage of a round object with a diameter of 30 millimetres.

Appropriately said at least one outlet hole 21 comprises a slot that extends along a curved wall 20 of the casing 2 defining a half-moon.

Preferably said at least one outlet hole 21 comprises a slit 22 having a width comprised between 30 and 40 millimetres. The slit 22 therefore has a longitudinal prevalent extension. The width being appropriately measured orthogonally to such longitudinal line.

In the preferred solution the casing 2 and the rotating element 3 are made of metal. More generally the fruits inside said casing do not come into contact with the rubber elements. Therefore, effective stone removal can also be obtained in the absence of rubber portions that swallow up the stone exploiting the elasticity thereof.

The method allows a semi-processed product to be obtained downstream of the casing 2 comprising:
the flesh 12 that has been separated from the stone 11; and
the stone 11 (to which residues of flesh can still in turn be attached).

Such semi-processed product is therefore a mush (the ground flesh) in which the stones are present.

The method further comprises the step of making said semi-processed product pass through a sieve 4 that retains the stone 11 allowing the passage of the flesh 12.

The step of making said semi-processed product transit through the sieve 4 comprises the step of making the semi-processed product pass through a first refining device comprising an impeller 5 that rotates in the sieve 4 and pushes the flesh through the sieve 4. The stones are instead retained by the sieve 4. The propeller 5 can for example rotate at a speed comprised between 800 and 1000 rpm, preferably at 900 rpm. The sieve can comprise holes having a diameter comprised between 5 and 10 millimetres (or however having a passage section comprised between 19.5 mm² and 78.5 mm²).

The propeller 5 is bladed and draws in rotation the stone 11 pushing it (due to the effect of the radial thrust imposed by the blade and by centrifugal effect) against the sieve 4 to determine a further detachment of flesh still attached to the stone 11. Appropriately the first refining device is placed at least in part below said casing 2. This allows a column-like extension of the apparatus 1.

The method can possibly envisage the step of making the useful product transit at the outlet from the first refiner (the one that crosses the sieve 4) to a second refining device. This could be useful for some types of products. For example, for retaining some types of skins. By way of example there are white nectarines that are distinguished by white flesh and red skin. In that case if the skin ended up in the purée it would compromise the colour thereof. The second refining device could therefore be used to prevent such drawback.

Downstream of the first refining device (and also of the second one if provided) there is a purée cooking system. This may be for example of the type described in EP2022342. Advantageously it comprises a recirculation system inside which heated purée circulates. The purée at the inlet then comes into contact straight away with a significant mass of already heated purée and therefore can be heated extremely quickly. Furthermore the first or the second refining device is located immediately above the inlet of the purée into the recirculation system. In this way the hot vapours coming from the recirculation system rise towards the first or second refining device allowing the oxidation of the product already upstream to be reduced, to heat it (as well as yielding the aroma of such vapours to the product without dispersing it).

The present invention achieves important advantages. First of all, it allows the fruit stone to be removed without the use of rubber rollers that by coming into contact with the product get worn releasing small particles that end up in the final product (intended to be eaten). Furthermore, the apparatus has a notable operating speed and this allows the exposure of the semi-processed product to oxidation to be minimised.

The invention as it is conceived is susceptible to numerous modifications and variations, all falling within the scope of the inventive concept characterising it. Furthermore, all the details can be replaced with other technically-equivalent elements. In practice, all the materials used, as well as the dimensions, can be any according to requirements.

1. A method for processing fruit (10) that has a central stone (11) and flesh (12) surrounding the stone, said method comprising the steps of:
positioning the fruit (10) inside a casing (2) in which a rotating element (3) rotates, said casing (2) comprising at least one outlet hole (21);
removing from the stone (11) at least a part of the flesh (12) attached to the stone (11);
characterised in that the step of removing from the stone (11) at least a part of the flesh (12) attached to the stone (11) comprises the step of pushing the fruit (10) by centrifugal force against the casing (2) and bringing said rotating element (3) into contact with the flesh (12) until the stone (11) manages to pass through said at least one outlet hole;
said method also comprising the steps of:
obtaining a semi-processed product downstream of the casing (2) comprising the stone (11) and the flesh (12) that was separated from the stone (11);
making said semi-processed product pass through a sieve (4) that retains the stone (11) allowing the passage of the flesh (12).

2. The method according to claim 1, characterised in that the step of removing the flesh (12) from the stone (11) comprises the step of positioning by centrifugal effect the stone (11) between the casing (2) and an imaginary circumference travelled by the outer diameter of a blade element (30) being part of the rotating element (3); said blade element (30) removing at least a part of the flesh attached to the stone (11) without coming into contact with the stone (11).

3. The method according to claim 2, characterised in that said blade element (30) rotates inside the casing (2) maintaining a radial distance from said casing (2) such as to allow the stone (11) to remain near the casing (2) without coming into contact with the blade element (30).

4. The method according to claim 1, characterised in that said at least one outlet hole (21) comprises a slot that extends along a curved wall (20) of the casing (2) defining a half-moon.

5. The method according to claim 1, characterised in that said at least one outlet hole (21) comprises a slit (22) having a width comprised between 30 and 40 millimetres.

6. The method according to claim 1, characterised in that said casing (2) and said rotating element (3) are made of metal.

7. The method according to claim 1, characterised in that the step of making said semi-processed product transit through the sieve (4) comprises the step of making the semi-processed product pass through a first refining device (41) comprising an impeller (5) that rotates in the sieve (4) and pushes the flesh through the sieve (4), the stones being retained by the sieve (4).

8. The method according to claim 7, characterised in that said impeller (5) is bladed and draws in rotation the stone (11) pushing it against the sieve (4) to determine a further detachment of flesh still attached to the stone (11).

9. A processing apparatus for processing fruit that has a central stone and flesh surrounding the stone, said apparatus comprising a stone remover, in turn comprising:
a rotating element (3);
a casing (2) inside which said rotating element (3) is placed, said casing (2) comprising at least one outlet hole (21) for letting out the stone and the flesh detached from the stone; said rotating element (3) being adapted to remove the flesh attached to the stone (11) and to draw in rotation the fruit placed inside the casing (2) pushing it by centrifugal force against said casing (2);
said apparatus (1) comprising a means (40) for separating the stone from the flesh (12) already detached from the stone, said separation means (40) being placed downstream of said casing (2).

10. The apparatus according to claim 9, characterised in that said rotating element (3) is coaxial with the casing (2).
